(19) United States
(12) Patent Application Publication
(10) Pub. No.: US 2024/0255699 A1
(43) Pub. Date: Aug. 1, 2024

(54) Heterogeneous Integrated UV-IR Ultra-Low Loss Multi-Layer Platform with Electrical Interconnects, Gain, Modulation, Detection, and Nonlinear Optics

(71) Applicants: The Regents of the University of California, Oakland, CA (US); Massachusetts Institute of Technology, Cambridge, MA (US); National Technology & Engineering Solutions of Sandia, LLC, Albuquerque, NM (US)

(72) Inventors: Daniel J. Blumenthal, Santa Barbara, CA (US); Matt Eichenfield, Albuquerque, NM (US); Dirk Englund, Cambridge, MA (US); Mikkel Heuck, Cambridge, MA (US)

(73) Assignees: The Regents of the University of California, Oakland, CA (US); Massachusetts Institute of Technology, Cambridge, MA (US); National Technology & Engineering Solutions of Sandia, LLC, Albuquerque, NM (US)

(21) Appl. No.: 18/393,392

(22) Filed: Dec. 21, 2023

Related U.S. Application Data
(60) Provisional application No. 63/479,966, filed on Jan. 13, 2023.
(60) Provisional application No. 63/476,605, filed on Dec. 21, 2022.

(51) Int. Cl. G02B 6/122

(52) U.S. Cl. CPC G02B 6/1228

(57) ABSTRACT

Systems and methods for hybrid integration of ultra-low loss waveguide photonic circuits with various efficient on-chip elements are described. The photonic circuits can integrate various elements including (but not limited to): gain, modulation, detection, and nonlinear optical elements. The integrated photonic chips can be manufactured in a flexible, reconfigurable, 3D heterogeneous platform. The integrated photonic chips can cover wavelength ranges from the visible wavelength to infrared wavelength.

### CROSS-REFERENCE TO RELATED APPLICATIONS

The current application claims the benefit of U.S. Provisional Patent Application No. 63/476,605 entitled “Heterogeneous Integrated UV-IR Ultra-Low Loss Multi-Layer Platform With Electrical Interconnects, Gain, Modulation, Detection, and Nonlinear Optics” filed Dec. 21, 2022, and U.S. Provisional Patent Application No. 63/479,966 entitled “Heterogeneous Integrated UV-IR Ultra-Low Loss Multi-Layer Platform With Electrical Interconnects, Gain, Modulation, Detection, and Nonlinear Optics” filed Jan. 13, 2023. The disclosures of U.S. Provisional Patent Application Nos. 63/476,605 and 63/479,966 are hereby incorporated by reference in their entirety for all purposes.

### STATEMENT OF FEDERALLY SPONSORED RESEARCH

This invention was made with government support under Contract No. DE-NA0003525 awarded by the United States Department of Energy/National Nuclear Security Administration. The government has certain rights in the invention.

### FIELD OF THE INVENTION

The present invention generally relates to methods and systems for hybrid integration of ultra-low loss waveguide photonic circuits with various on-chip elements.

### BACKGROUND

An electronic integrated circuit (EIC) is a chip containing electronic components that form a functional circuit. In an electronic chip, electrons in the form of current and voltage potentials interact with electrical components such as resistors, inductors, transistors, and capacitors to realize electronic functions. A photonic integrated circuit (PIC) is a chip that contains photonic components, which are components that route and perform functions on light (photons) under the control of, or interfacing with electrical signals and sometimes under the control of optical signals. In a photonic chip, photons pass through optical “wires” or optical waveguides (analogous to an electrical wire), and components such as lasers and optical amplifiers, photodetectors, modulators, resonators, delay lines, isolators, optical polarizers, and phase shifters are used to generate, manipulate, and detect light and optical signals. PICs may use a laser source to generate light, that can be from the UV, through the visible and near IR, into the mid-IR and IR. PICs may require gain blocks similar to an electrical amplifier to boost the optical signal. PICs may require modulation of the optical signal to realize control and lock loops or modulation to impress information onto the optical signal. Similar to the advantages offered by electronics, PICs offer advantages such as miniaturization, lighter weight, smaller size, lower cost, lower power consumption, large scale integration and scalability, improved reliability, and the ability to integrate systems-on-chip.

### BRIEF SUMMARY

Methods and systems for hybrid integration of ultra-low loss waveguide photonic circuits with various on-chip elements are described.

Some embodiments include an integrated photonic platform comprising: at least one optical waveguide layer on a substrate, wherein the at least one optical waveguide layer comprises a plurality of active elements; and at least one socket to connect each of the plurality of active elements; wherein the plurality of active elements is optically and electrically connected using an epitaxial tapered waveguide micro-chiplet geometry.

In some embodiments, at least one of the plurality of active elements is selected from the group consisting of: a gain element, a modulation element, a detection element, and a nonlinear optical element.

In some embodiments, at least one of the plurality of active elements is selected from the group consisting of: a semiconductor laser, an extended cavity tunable laser, an optical amplifier, an optical modulator, a non-magnetic optical isolator, a non-magnetic optical circulator, a detector, a frequency shifter, and a free-space grating emitter.

In some embodiments, the at least one socket further comprises at least one direct-gain tapered waveguide gain die.

In some embodiments, the at least one direct-gain tapered waveguide gain die comprises a III-V semiconductor material.

In some embodiments, the at least one direct-gain tapered waveguide gain die comprises a material selected from the group consisting of: GaN, InGaN, AlGaN, AlInGaP, InGaAs, InAs, AlGaAs, GaAs, InN, and AlN.

In some embodiments, the at least one direct-gain tapered waveguide gain die comprises a material selected from the group consisting of: GaN, InGaN, and AlGaN, and the integrated photonic platform covers a wavelength range from 400 nm to 530 nm.

In some embodiments, the at least one direct-gain tapered waveguide gain die comprises a material selected from the group consisting of: InGaN and AlInGaP, and the integrated photonic platform covers a wavelength range from 530 nm to 600 nm.

In some embodiments, the at least one direct-gain tapered waveguide gain die comprises a material selected from the group consisting of: GaN, AlInGaP, GaAs, and InGaAs, and the integrated photonic platform covers a wavelength range from 600 nm to 900 nm.

In some embodiments, the at least one direct-gain tapered waveguide gain die comprises a material selected from the group consisting of: AlN, GaN, AlInGaP, GaAs, InGaAs, and InP, and the integrated photonic platform covers a wavelength range from 200 nm to 1800 nm.

Some embodiments further comprise a tunable LiNbO₃ or a barium titanate (BTO) second-harmonic-generation (SHG) laser chiplet that integrates into the at least one socket.

In some embodiments, the platform covers a wavelength range from 530 nm to 600 nm.

In some embodiments, the at least one optical waveguide layer comprises a material selected from the group consisting of: silicon nitride, aluminum oxide, tantalum pentoxide, and aluminum nitride, and the integrated photonic platform covers a wavelength range from 200 nm to 2350 nm.

Some embodiments further comprise at least one of: a stress-optic actuator layer, and a metal interconnection layer.

In some embodiments, the stress-optic actuator layer comprises aluminum nitride or PZT.

In some embodiments, the substrate is a flexible substrate.

In some embodiments, the platform is configured to be a portion of: a cold-atom based quantum computer, a cold-atom atomic clock, or a quantum sensor.

In some embodiments, the platform is compatible with a CMOS foundry fabrication process.

In some embodiments, a plurality of functional blocks comprises a plurality of chiplets connected to the at least one optical waveguide layer, wherein at least one of the plurality of chiplets is selected from the group consisting of: a semiconductor gain, a nonlinear optical element, a modulator, a frequency shifter, a detector, and an optical amplifier.

Additional embodiments and features are set forth in part in the description that follows, and in part will become apparent to those skilled in the art upon examination of the specification or may be learned by the practice of the disclosure. A further understanding of the nature and advantages of the present disclosure may be realized by reference to the remaining portions of the specification and the drawings, which forms a part of this disclosure.

### BRIEF DESCRIPTION OF THE DRAWINGS

The description will be more fully understood with reference to the following figures, which are presented as exemplary embodiments of the invention and should not be construed as a complete recitation of the scope of the invention. It should be noted that the patent or application file contains at least one drawing executed in color. Copies of this patent or patent application publication with color drawing(s) will be provided by the Office upon request and payment of the necessary fee.

FIG. 1 illustrates a PIC integration platform architecture, waveband allocation, component toolkit and demo applications in accordance with an embodiment.

FIG. 2 illustrates PIC waveband allocation and ultra-low loss dual window waveguiding layers in accordance with an embodiment.

FIGS. 3A-3H illustrate low loss waveguides, sub-Hz lasers, and surface emitting gratings in accordance with prior art.

FIG. 4A illustrates an inverse taper coupler and simulated field profiles at 3 cross sections in accordance with an embodiment.

FIG. 4B illustrates coupling efficiency simulations in accordance with an embodiment.

FIGS. 5A-5C illustrate heterogeneous integration of amplifier gain chiplet, coherent combiner, and SHG chiplets in accordance with an embodiment.

FIGS. 6A-6C illustrate layer structures for III-Nitride gain materials in the 400-590 nm range in accordance with an embodiment.

FIGS. 7A-7C illustrate gain layer structure for about 650-900 nm, near 6XX nm, and about 1060-1200 nm in accordance with an embodiment.

FIG. 8A illustrates simulation of SHG phase-matching in accordance with an embodiment.

FIG. 8B illustrates an out-coupling scheme in accordance with an embodiment.

FIG. 8C illustrates LiNbO₃ membrane transfer to PIC in accordance with embodiment.

FIG. 8D illustrates simulated pump (top) and SHG (bottom) power vs. waveguide length in accordance with an embodiment.

FIGS. 9A-9C illustrate remote epitaxial III-V thin films and integration in accordance with an embodiment.

FIG. 10A illustrates a side view of integrated MC in accordance with an embodiment.

FIG. 10B illustrates a CAA design showing a generic detector in accordance with an embodiment.

FIG. 10C illustrates a 3D illustration of integration process in accordance with an embodiment.

FIG. 10D illustrates a four-waveguide SOA for pre-amplification before CAA in accordance with an embodiment.

FIG. 11A illustrates an ultra-low linewidth tunable laser 3-resonator at 1550 nm in accordance with prior art.

FIG. 11B illustrates tuning of 1550 nm ECTL in accordance with prior art.

FIG. 11C illustrates 674 nm ECTL mask in accordance with prior art.

FIG. 11D illustrates plots showing fundamental linewidths at wavelength ranges 400-900 nm and 1060-1200 nm in accordance with an embodiment.

FIG. 12A illustrates a coupled stress-optic AlN ring modulator in accordance with prior art.

FIG. 12B illustrates a coupled stress-optic AlN modulator in accordance with an embodiment.

FIG. 13A illustrates imparting equivalent angular moment via stress-optic index modulation in accordance with an embodiment.

FIG. 13B illustrates three coupled ring nonmagnetic optical isolator with RF drive signals 120 degrees off-set from each other in accordance with an embodiment.

FIG. 13C illustrates a schematic of implementation in PIC platform in accordance with an embodiment.

FIG. 13D illustrates a fabricated three-port optical isolator/circulator in accordance with an embodiment.

FIG. 14 illustrates a heterogeneous integration platform showing 8 epitaxially grown gain/laser materials platforms integrated onto the active photonic integrated circuit platform via a flipped transfer print process in accordance with an embodiment.

FIG. 15 illustrates a transfer printing process in accordance with an embodiment.

FIG. 16A illustrates atom array quantum computing in accordance with an embodiment.

FIG. 16B illustrates strontium AC laser cooling and OLO in accordance with an embodiment.

FIG. 16C illustrates a trapped ion optical clock operation in accordance with an embodiment.

### DETAILED DESCRIPTION

PICs with very low loss optical wires or waveguides, are important for many applications including optical communications, fiber sensing, atomic clocks, quantum sensors, quantum computers, quantum communications, position and navigation, fundamental science, automotive, and astronomy. Fabrication of low loss PICs with existing processing flows, for example CMOS foundry compatible, allow for high yield, volume manufacturing, and lower prices.

Many applications require augmentation of an ultra-low loss PIC integration platform with functions provided by other material systems. For example, an ultra-low loss PIC with low loss waveguides can heterogeneously incorporate semiconductor gain to realize lasers and optical amplifiers and switches. Different semiconductors can be heterogeneously incorporated to provide lasers and gain at wavelength compatible with the low loss waveguides, for example in the UV, Visible, Near-IR and Mid-IR. Other heterogeneous materials that can be incorporated with the low loss waveguide platform can provide nonlinear optic functionalities such as frequency conversion. Other heterogenous materials can be combined with the low loss waveguide platform to provide high speed modulation and photodetection. Such heterogeneous integration can be provided on the low loss waveguide platform directly by placing other material functions using chiplet type technology or by involving subsequent 3D layers with direct deposition or growth. Post assembly of complete PICs is also a desirable path to incorporate functionality from multiple material platforms into a common PIC integration platform.

Many embodiments provide PIC integration platforms that enable complex PICs and systems on chip by combining the functionality and benefits of multiple material systems and devices to that of a low loss PIC integration platform.

Many embodiments implement hybrid integration of ultra-low loss waveguide photonic circuits with various efficient on-chip elements including (but not limited to): gain, modulation, detection, and nonlinear optical elements. In several embodiments, the integrated photonic chips can be manufactured in a flexible, reconfigurable, 3D heterogeneous platform. In some embodiments, the integrated photonic chips can cover wavelength ranges from the deep UV to the near UV and UV, to the visible wavelength to near-IR, mid-IR and infrared (IR) wavelengths (from about 200 nm to about 2350 nm). Many embodiments utilize heterogeneous photonic integrated circuits that contain one or more optical waveguide layers. Sockets (etched pockets) can be used to connect active elements to various low loss waveguide layers in accordance with certain embodiments. In some embodiments, the sockets can connect active elements including (but not limited to) semiconductor lasers, amplifiers, and other elements that are optically and electrically connected using an epitaxial tapered waveguide micro-chiplet geometry. In several embodiments, the sockets can be populated using a transfer print process with direct-gain inverse-taper waveguide gain die, and/or other appropriate semiconductor gain or nonlinear optical materials that can be allocated into wavebands spanning the desired wavelength range. Some embodiments implement a transfer print process with direct-gain GaAs and III-Nitride-based inverse-taper waveguide gain die, allocated into about 8 wavebands; or greater than about 8 wavebands; or less than about 8 wavebands; spanning from about 200 nm wavelength to about 1800 nm wavelength. Many embodiments utilize a CMOS-like, multi-layer platform that can support arbitrary connections of gain, modulation and nonlinear optical elements to ultra-low loss waveguides and routing layers, including the ability to route any waveguide through a stress-optic actuated layer, a wide range of active and passive devices, and a multi-layer electrical interconnect.

Several embodiments provide the PIC heterogeneous integration approach for efficient on-chip gain in a high-performance, flexible, 3D heterogeneous, visible-light-integrated photonics platform. The platform is a reconfigurable, CMOS-like solution for visible light applications. The PIC integration in accordance with many embodiments is a “wavelength by design” photonic integrated circuit (PIC) substrate containing sockets for semiconductor laser and amplifier epitaxial (EPI) micro-chiplets (MCs) populated with direct-gain AlGaAs- and III-Nitride-based tapered waveguide gain die spanning the 400-900 nm wavelength range in 8 wavebands. Wider wavelength ranges can be accommodated in various embodiments using more wavebands to cover from about 200 nm to about 1800 nm, or from about 200 nm to about 2350 nm. For the 530-600 nm range, some embodiments provide materials for direct gain, and as a backup plan, a tunable LiNbO₃ second-harmonic-generation (SHG) laser chiplet or a barium titanate (BTO) SHG laser chiplet that integrates into the same EPI MC sockets can be pumped by extended-band low linewidth tunable lasers. Such platform provides multi-layer, ultra-low loss waveguide routing, stress-optic DC and RF actuation layers, multi-layer electronic interconnects, ultra-low linewidth tunable lasers, amplifiers, modulators, non-magnetic optical isolators/circulators, detectors, and free-space grating emitters. The platform can be used in applications such as cold-atom based quantum computing, and/or cold-atom atomic clocks.

Many embodiments provide at least one property of the heterogeneous integrated photonic chips including (but not limited to):
Reconfigurable, flexible, tunable, ultra-narrow linewidth extended cavity (less than about 100 Hz) multi-laser front-end interfaced with on-PIC high-performance active and passive toolkit;
direct gain amplifiers and laser micro-chiplet die connected to inverse-taper waveguide layers such as (but not limited to) SisN₄ and Al₂O₃ waveguide layers through optically and electrically contacted PIC sockets (self-aligned micro-chiplet sockets);
III-V compound semiconductor such as (but not limited to) GaAs and III-Nitride tapered waveguide direct gain die arrays segmented into 8 wavebands with materials to cover the wavelength range from about 400 nm to about 900 nm;
a secondary approach to cover the wavelength range from about 530 nm to about 600 nm by SHG with tapered waveguide tunable LiNbO₃ chiplets pumped by (not limited to) 1060 nm/1200 nm tunable III-V lasers;
a PIC platform that enables mask-only changes to access ultra-low loss Si₃N₄ and Al₂O₃ waveguide routing layers and connect to an AlN stress-optic actuation layer and electrical interconnects;
a gain chiplet die connected to inverse tapered waveguides using a transfer print process of pre-assembled die;
an extended cavity widely-tunable ultra-high quality factor resonator design for 100 Hz intrinsic linewidth widely-tunable lasers;
AlN or PZT actuated 500 MHz modulators for control and fast wavelength scanning;
flexible active and passive component toolkit for visible wavelength to near infrared wavelength applications;
wavelength-by-design for all components realizable in any waveguide layer by mask-only changes;
high-gain tapered waveguide coherent amplifier array chiplets for high output saturation power gain across all wavebands;
less than about 1 MHZ; or less than about 1 kHz; or less than about 100 Hz intrinsic line width tunable lasers; less than about 1 Hz linewidth stimulated Brillouin scattering laser; and
functions for atom manipulation and interrogation including surface grating emitters.

The PIC integration platforms enable at least eight, 100 Hz intrinsic linewidth lasers, covering any portion of the 400 nm-900 nm wavelength range. Extended operation down to 200 nm and out to 2350 nm is also possible. Each laser can be tunable over a 62.5 nm range with greater than about 16 dBm output power, integrating all lasers, active and passive components using wavelength by design and mask-only design changes. Other tuning ranges may be desirable.

The ultra-low loss optical waveguides in accordance with many embodiments are compatible with CMOS manufacturing processes and other semiconductor device manufacturing processes. The ultra-low loss optical waveguides can be fabricated without using high temperatures. Elimination of high temperatures during fabrication can be desirable to applications that use CMOS circuit processes and other processes without high temperatures. Several embodiments can reduce the cost and improve the manufacturability of photonic and electronic-photonic circuits, as well as expand the applications to data centers, fiber communications, and precision visible applications including atomic clocks, quantum sensing and computing, precision metrology.

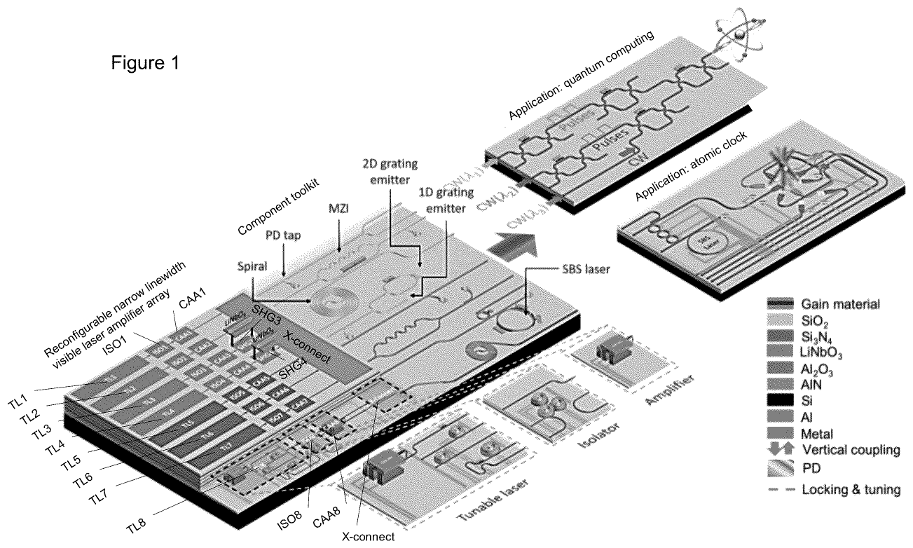

Systems and methods for heterogeneous integrated ultra-low loss and multi-layer platforms in accordance with various embodiments of the invention are described. FIG. 1 illustrates a PIC platform architecture, waveband allocation, component toolkit and demo applications in accordance with an embodiment. As shown in FIG. 1, the PIC 3D heterogeneously integrated architecture contains ultra-low linewidth tunable lasers, optical amplifiers, stress-optical actuators and modulators, non-magnetic optical isolators, ultra-low loss optical waveguiding layers, integrated detectors, and an active and passive component toolkit. It operates across 400-900 nm wavelength range and provides multiple electronic interconnect layers for control and feedback. The front-end contains arrays of extended cavity tunable lasers (ECTLs), non-magnetic optical isolators (NMOIs), coherent amplifier arrays (CAAs) and SHG modules (when needed). An optical switch array can be used to route the wavelengths for reconfigurable applications. The PIC platform enables applications such as a cold-atom quantum computer and a cold-atom strontium atomic clock laser. The PIC platform is populated with tapered waveguide gain and SHG micro-chiplets (MCs), assembled by print transfer, for the required laser wavelengths and supports passive and active components and functions to manipulate and interrogate atoms applications such as: quantum computing and strontium atomic clock/ion trap.

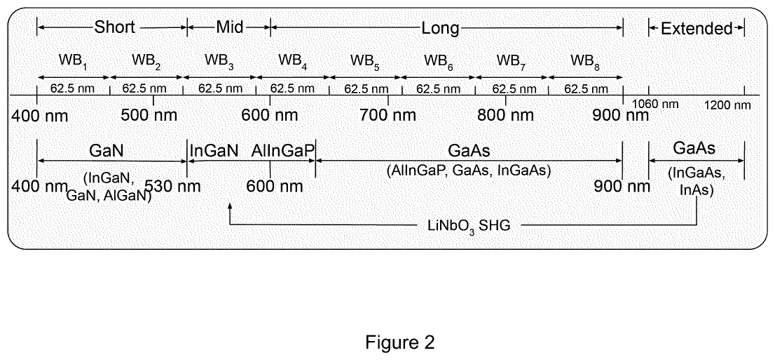

FIG. 2 illustrates a PIC waveband allocation and ultra-low loss dual window waveguiding layers in accordance with an embodiment. FIG. 2 shows eight, 62.5 nm wavebands (WB₁-WB₈), that cover the 400-900 nm range, each fabricated in a material system on one of eight epitaxially grown wafers for direct gain. Wavebands are defined in order to drive standardization and uniformity of gain EPI materials and wafers that will transfer more readily to a foundry model and PDK based design rules. These wavebands are served by transferable die from EPI gain materials processed into inverse-tapered waveguide MC gain die. Single-taper designs are used for laser MC gain die and double-taper designs used for SOA and CAA MC gain die. These MC gain dies are heterogeneously integrated, using print transfer techniques, with the multi-layer PIC that contains ultralow loss Si₃N₄ and Al₂O₃ waveguide layers and a stress-optic aluminum nitride (AlN) actuator layer, as well as multiple electrical interconnect layers, to realize a wide range of tunable/modulable high performance passive and active components. Some embodiments can achieve 100 Hz linewidth, greater than about 16 dBm output power extended cavity tunable lasers (ECTL) based on WB₁-WB₈ direct gain. For the WB₃/WB₄, several embodiments achieve direct gain ECTLs operating in WB₃₊/WB₄₊ by pumping LiNbO₃ SHG chiplets. For mid-band wavelengths (from about 530 to about 600 nm), several embodiments use SHG from 1060-1200 nm extended-band ECTLs using LiNbO₃ MCs coupled to Si₃N₄ PIC waveguides. The mapping of channels to the short-, mid-, and long-bands can depend on the direct gain materials development roadmap. The short-band can be covered with III-N materials and the long-band and extended-band with III-V materials (based primarily on GaAs). Several embodiments may implement processes for remote epitaxy of single-crystal, thin-film lift-off of the gain chiplet die. For each epitaxial material set, a nominal growth stack with the largest possible output power bandwidth (measured at 3 dB width) can be established.

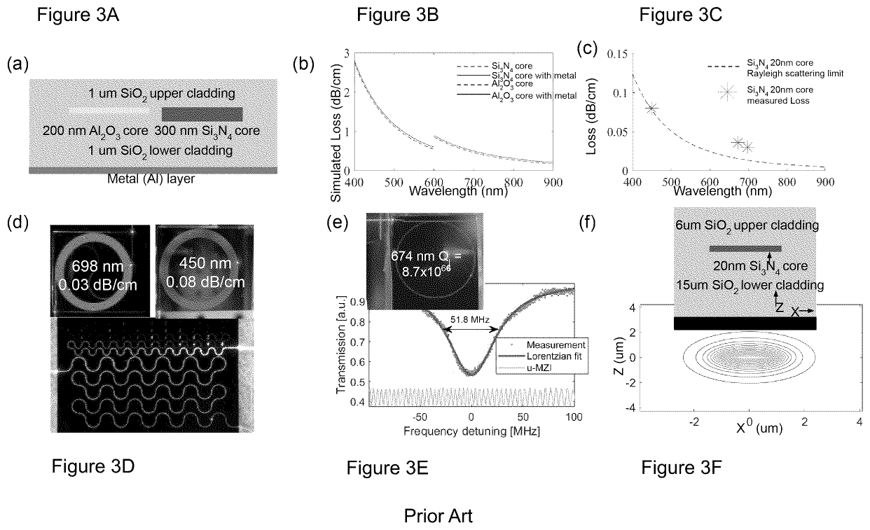

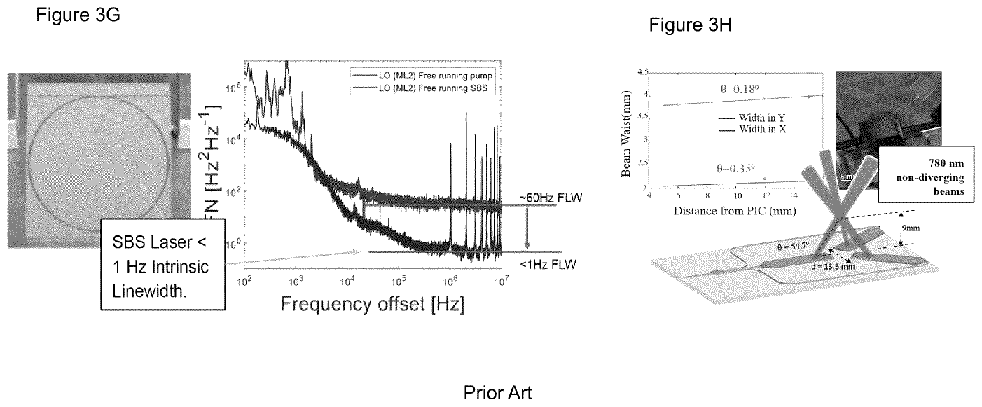

The PIC platform in accordance with some embodiments provides dual waveguide layers (Si₃N₄ and Al₂O₃) with loss less than about 6 dB/cm across the 400-900 nm spectrum; or less than about 1 dB/cm across the 400-900 nm spectrum. Two waveguide routing layers are available, one in Al₂O₃ (optimized for ˜400-600 nm) and one in Si₃N₄ (optimized for ˜600-900 nm). FIG. 3A illustrates a low loss waveguide cross section. In some embodiments, 200 nm thick Al₂O₃ and 300 nm thick Si₃N₄ waveguide cores with layer tops aligned are fabricated using mask-only changes on top of 1.1 and 1 μm oxide lower cladding respectively. An Al metal layer exists under the lower cladding for electrical interconnection (e.g. strain actuator control, photodiodes, etc.). In some embodiments, the waveguide layers can be enhanced with an additional set of waveguide layers to allow fabrication of long delay structures. The second set of waveguide layers can have a 500 nm shared gap cladding that vertically taper connect to their respective primary layers. The designer can route devices and waveguides between the two sets of waveguides with mask-only changes. FIG. 3B illustrates simulated losses of the waveguide in FIG. 3A. FIG. 3B shows simulated loss by considering Rayleigh scattering as the dominant factor and using measured loss value at 780 nm with and without metal, achieving the less than 1 dB/cm loss metric. The 20 nm thickness Si₃N₄ core loss has low losses at less than about 0.1 dB/cm at 450 nm and about 0.03 dB/cm at 698 nm, limited by Rayleigh scattering (FIG. 3C). FIG. 3D illustrates images and measured losses in a 2-meter Si₃N₄ spiral and cutback waveguide. The spontaneous Brillouin gain at 674 nm in Si₃N₄ representing visible SBS gain demonstrated in a PIC waveguide. FIG. 3E illustrates a resonator. The resonator has a quality factor of about 8.7 million at 674 nm. FIG. 3F illustrates a waveguide cross section of the waveguides shown in FIGS. 3C and 3D. For the PIC platform, losses can be simulated using finite element method (FEM) for varying waveguide geometry and lower cladding thickness to optimize propagation losses with a metal (Al) tuning layer. Other parameters optimized are the Al₂O₃ core thickness and SiO₂ lower cladding. Loss of less than about 0.1 dB/cm for 400-900 nm can be achieved and total propagation losses in Si₃N₄ can be 0.3 dB/cm at 780 nm and 1 dB/cm at 630 nm. A sub-Hz linewidth SBS laser can be integrated. The SBS design can be based on a 1550 nm sub-Hz (˜0.7 Hz) laser shown in FIG. 3G.

Vertically emitting gratings for \ of about 698 nm and 816 nm; grating emitters operating at \ of about 461 nm, 689 nm, 679 nm and 707 nm emitting at 54.7°; a Si₃N₄ planar waveguide laser cooling interface PIC for a Rb-87 3D-MOT at λ at about 780 nm; have been achieved. These PICs convert light from single mode Si₃N₄ waveguides to three large area (˜4 mm×2 mm) free-space beams intersecting orthogonally 9 mm above the PIC surface within the 3D-MOT. The emitted beams are collimated, with divergence half angle less than about 0.6° removing the need for collimating lenses. Several embodiments achieve similar gratings at >=461 nm, 679 nm, 689 nm and 707 nm for 54.7º emission and have experimentally verified the diffraction angle. FIG. 3H illustrates 780 nm cooling beams for 3D-MOT interface.

Certain embodiments use designs for 1×3 MMI splitters, 50:50 directional couplers, 66:33 directional couplers and 33:33:33 (3×3) directional couplers that address fabrication issues in order to deliver equal outputs.

As shown in FIGS. 3A-3H, the Si₃N₄ platform as well as other key passives like splitters, combiners can achieve the low loss for strontium wavelengths and an 8.6 million Q resonator at 674 nm. Platform-compatible active components include stress-actuated phase shifters and modulators, non-magnetic optical isolators/circulators, coherent optical amplifier arrays and photodetectors, operating across the full spectrum. The component count may exceed 100 and system spectral bandwidth greater than ½ octave. The wall-plug efficiency metric can be achieved with low energy components like the AlN waveguide stress actuators. The toolkit can be customized for two different atom manipulation and interrogation systems: (i) a Rubidium cold-atom trapping and measuring interface to control single- and multi-qubit quantum gates and (ii) a strontium optical clock laser cooling beam and optical laser oscillator (OLO) delivery interface.

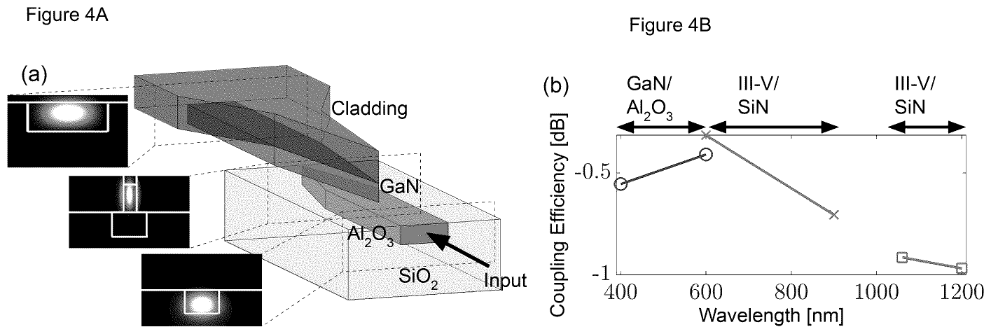

Some embodiments couple the gain MCs to the PIC platform using inverse taper couplers. FIG. 4A illustrates an inverse taper coupler and simulated field profiles at 3 cross sections in accordance with an embodiment. FIG. 4B illustrates coupling efficiency simulations in accordance with an embodiment. The 3D finite difference time domain simulations for a representative set of wavelengths and material compositions across all wavebands show that efficient coupling is possible, see FIG. 4B. It can be challenging to transfer the optical mode into the gain MC due to the small index contrast between the waveguide layer and cladding (Δn˜0.1) but tapering the cladding and increasing coupling length results in high coupling efficiency. Some embodiments use alignment-robust designs to alleviate the accuracy restrictions of the transfer printing process.

PIC platforms in accordance with many embodiments provide heterogeneously (3D) integrated gain across the 400-900 nm range using uniform-design, waveguide-tapered semiconductor gain array die that are optically and electronically self-aligned to ultra-low loss waveguide inverse tapers.

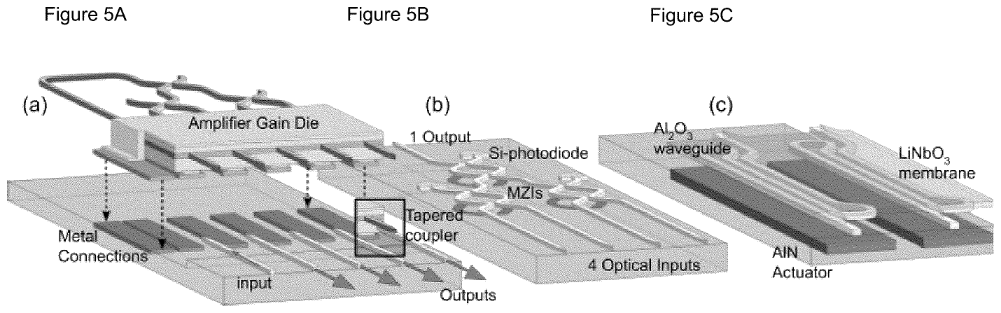

FIGS. 5A-5C illustrate heterogeneous integration of amplifier gain chiplet (5A), coherent combiner (5B), and SHG chiplets (5C) in accordance with an embodiment. The tapers, etch features, and electrical contacts are self-aligning. The gain materials are nominally segmented by wavebands (FIG. 2). Tapered gain-array dies can be cleaved from 8 waveband-specific MOCVD epitaxial wafers that span the 400-900 nm range in 62.5 nm increments and attach to the PIC platform using a wafer-scale transfer print process. These dies, in combination with active and passive components in the associated waveguide layer, are used for low linewidth lasers, coherent amplifier arrays, and semiconductor optical amplifiers (SOAs). To build on the above approach, some embodiments use a process for remote epitaxy of single-crystal, thin-film lift-off of the gain chiplet die. The gain materials include (but are not limited to): InGaN (400-550 nm), AlInGaP (550-760 nm), and GaAs/AlGaAs (760-900 nm). In addition to the direct gain lasers and amplifiers, a platform-compatible risk mitigation solution for the mid-band gain materials (530-600 nm) uses the same building blocks with the addition of a waveguide-tapered LiNbO₃ SHG chiplet die (FIG. 5C). The SHG blocks are pumped with lasers using InGaAs(P) as gain materials operating at 1060-1200 nm. Several embodiments achieve laser output power metrics with a coherent amplifier array (CAA) including a multi-pass gain die (FIG. 5A) connected to a Mach-Zehnder Interferometer (MZI)—based coherent combiner (FIG. 5B) fabricated in the Si₃N₄ or Al₂O₃ waveguide layer with stress-actuated phase control and Si photodiodes.

The gain materials can include: InGaN (400-590 nm), AlInGaP (590-760 nm), and GaAs/AlGaAs (760-900 nm). In addition to the direct gain lasers and amplifiers, a platform-compatible risk mitigation solution for the midband gain material (530-600 nm) uses similar gain MCs based on InGaAs(P) emitting at 1060-1200 nm to pump the LiNbO₃ SHG MC. The laser output power can be improved with a coherent amplifier array (CAA) including a parallel SOA array connected to an MZI-based coherent combiner fabricated in the Si₃N₄ or Al₂O₃ waveguide layer with stress-actuated phase control and photodetectors for each waveband consisting of single-tapered MC die operated in reverse-bias detector mode.

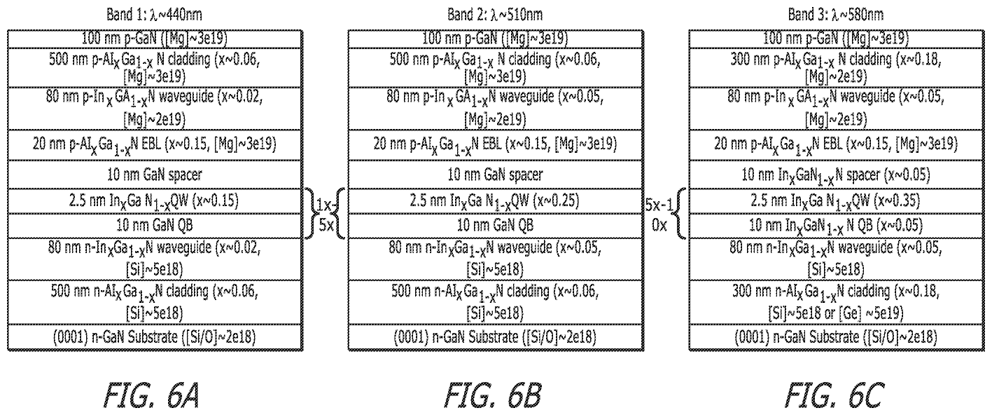

III-Nitride based multiple quantum well (MQW) gain EPI can be developed to cover the 400-525 nm range (WB1/WB2). FIGS. 6A-6C illustrate layer structures for III-Nitride gain materials in the 400-590 nm range in accordance with an embodiment. FIG. 6A shows the proposed epitaxial structure to be grown by metalorganic chemical vapor deposition (MOCVD) on a free-standing n-type GaN substrate. The approach is to close the green-gap from both directions (from the blue side and the red side). For III-N gain, the 1-5 layers MQW emission wavelength is tuned through the In mole fraction in the wells—as an example, approximately 15% indium mole fraction typically results in emission wavelength of about 450 nm for a blue LD. AlGaN can be used as upper and lower cladding and GaN (or dilute InGaN) waveguide layers for optical confinement. As the wavelength increases to 480 nm or more, the waveguide indium composition can be increased from about 0-2% for blue LDs to about 5% for green LDs to improve optical index contrast. The indium composition in the QWs also increases to about 25%, as shown for the 510 nm example in FIG. 6B. Across this 400-525 nm range, a thin p-type AlGaN electron blocking layer (EBL) can be grown immediately before or after the waveguide layer to prevent electron spill-over into the p-cladding. While the structures discussed so far are relatively well understood, the III-Nitride system still exhibits several fundamental properties that make the upper end of this 400-525 nm range challenging. The first is the quantum confined Stark effect (QCSE) that results in band-bending inside the quantum wells due to spontaneous and piezoelectric polarization fields along the c-axis. This band bending causes electrons and holes to accumulate on opposite sides of the QW which can reduce wave function overlap. Secondly, the larger indium concentration at longer wavelengths exacerbates strain and increases the density of crystalline defects. These challenges may give rise to the so-called “green gap”, where the nitride emitter efficiency falls off dramatically in the 500-600 nm range.

QW gain material on GaAs can be used to cover much of the 600-900 nm range. Arguably, an aluminum-free structure simplifies fabrication. InGaAsP on GaAs covers from 870 nm (GaAs) to 650 nm (lattice matched Inga). Therefore, for approximately 700-850 nm, Inga Asp QWs are commonly leveraged (808 nm lasers can be fabricated this way). For wavelengths above or close to 850 nm, GaAs or compressively strained InGaAs QWs can be used (typical barrier material is AlGaAs). For wavelengths below or close to 650 nm, strained Inga QWs can be used. AlInGaP is commonly utilized for the cladding layers because Inga is not trivial to grow on on-axis GaAs.

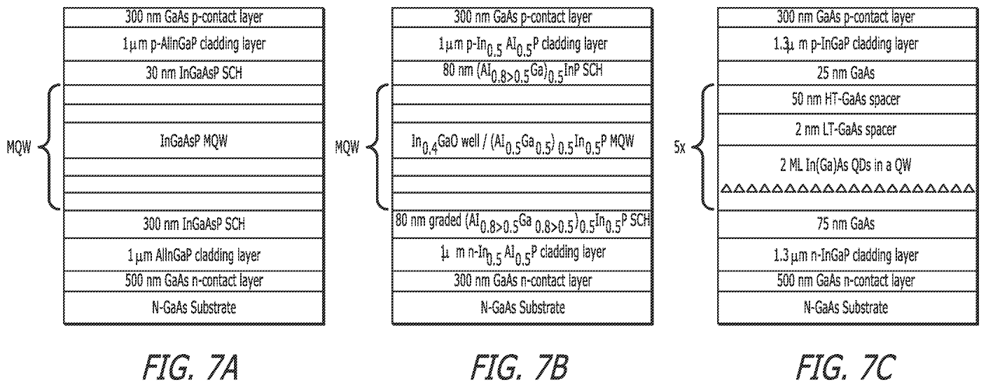

FIGS. 7A-7C illustrate gain layer structure for about 650-900 nm, near 6XX nm, and about 1060-1200 nm in accordance with an embodiment. The layer structure described in FIG. 7A proposes an MQW design that can be leveraged to cover much of this wavelength regime. AlInGaP has been widely recognized as a candidate for efficient optoelectronic devices in the red spectral region (620-780 nm). Low threshold and robust laser diodes and LEDs have been commercialized with this material system. A general proposed epitaxial scheme for the 6XX nm wavelength regime is described in FIG. 7B. Misoriented (001) GaAs substrates towards the direction and tensile strained Inga QWs enable Watt class high power laser diodes emitting near 630 nm. An emerging area for AlInGaP-based alloys is focused on improving red laser characteristics. Quantum dots (QDs), appealing for their unique characteristics such as three-dimensional carrier confinement and sharp density of states function, have been established in the near infrared regime (1300-1550 nm). Therefore, lower threshold, higher output power, higher wall-plug efficiency, reduced temperature sensitivity, as well as lower linewidth enhancement factor (LEF) can also be anticipated in the visible spectral regime. In/Inga/AlInGaP QDs have demonstrated the potential for operation near 730 nm with an extremely low threshold, a tunable wavelength window from 630-780 nm, and a dual-wavelength laser emission. A typical short wavelength laser commonly leverages In QDs in a In/InGa/AlInGaP structure. QD lasers by MOCVD that cover about 1240-1300 nm have been shown. To broaden this range to 1060 nm several approaches such as decreasing the indium composition of the InGaAs well or decreasing the indium arsenide (InAs) coverage, or decreasing the growth temperature to form smaller QDs may be used. A high performance 1080 nm laser with InAs/GaAs QDs can be achieved. A proposed layer stack for such 1060-1200 nm QD gain is shown in FIG. 7C.

Several embodiments provide “green-gap” (from about 530 nm to about 600 nm) gain approaches. The 530-600 nm wavelength region presents challenges. The shortest wavelength demonstrated for GaAs QW lasers is about 610 nm, where highly strained Inga QWs are employed. There have been very few demonstrations of III-Nitride LDs at wavelengths above about 530 nm. However, several materials and device improvements have enabled III-N light emitters at longer wavelengths. These include the use of QDs and exploiting morphological defect. In the case of quantum dots, researchers grew multiple quantum dot layers for the active region with reduced quantum confined stark effect (QCSE) compared to traditional quantum wells. They also used InAlN cladding layers with improved index contrast, while also being lattice-matched to the GaN substrate to reduce strain effects. Together, these improvements allowed for a QD LD at 630 nm with pulsed output power of nearly 30 mW. (See, e.g., D. P. Bour, et al., IEEE Photonics Technol. Lett. 6, 128 (1994); T. Frost, et al., IEEE Journal of Quantum Electronics, 49, 923 (2013); G. Weng, et al., Opt. Express 24, 15546 (2016); M. Zhang, et al., Applied Physics Letters 98, 221104 (2011); W. Lv, et al., Nanoscale Res. Lett. 7, 617 (2012); T. Frost, et al., 2015 IEEE Photonics Conference (IPC) (2015); the disclosures of which are incorporated by reference.) “V-pits” in InGaN green-yellow LEDs resulted in record efficiencies across the 520-585 nm range and has potential to be a game-changer in the field of III-Nitride light emitters. (See, e.g., F. Jiang, et al., Photon. Res., PRJ 7, 144 (2019); the disclosure of which is incorporated by reference.) The main approach to the 530-590 nm wavelength band (WB₃) in accordance with embodiments is to use multiple (5-10) InGaN quantum dot layers for the active region to access the longer wavelength range. This could potentially be combined with the V-pit injection to improve electrical injection. An example EPI structure is shown in FIG. 6C. Compared with the epi structures in FIGS. 6A and 6B, this design uses InAlN lattice-matched cladding layers for improved optical confinement as well as QD instead of QW active regions. InGaN barriers with indium mole fraction of about 5% are used instead of GaN barriers to help reduce polarization effects. A final distinguishing characteristic is the use of highly Ge-doped lower cladding layer. As mentioned previously, the index contrast between waveguide and cladding shrinks at longer wavelengths. By doping the n-side cladding much higher (˜5×10¹⁹ cm⁻³ Ge doping, or greater) a significant reduction in the optical index is realized thus improving index contrast. Some embodiments provide solutions of 530-600 nm green-gap from the longer wavelength side. One possible solution is to blue-shift the emission wavelength of the existing AlInGaP-based laser diode material to cover this gap. Although the shortest emission wavelength for the AlInGaP material system is 610 nm, experimental results revealed that a significant blue-shift can be obtained from red to green by (1) strain-induced quantum well intermixing (QWI), and (2) inserting tensile strained gallium phosphide (GaP) on (611)A and (211)A GaAs substrates to block electrons. In the first case, a set of as-grown Inga/AlInGaP samples are capped with SiO₂ and subjected to high temperature rapid thermal annealing. With strain-induced Al atom diffusion QWI, wavelength tunability over the range of 640-565 nm can be achieved and yellow LEDs demonstrated. For the latter case, lasing near 569 nm is achieved at 85K with a low threshold density of 400 A/cm², and yellow band near 585 nm at 210K. These results reveal compatibility of Inga/AlInGaP QWs for the green-yellow-red spectral regime.

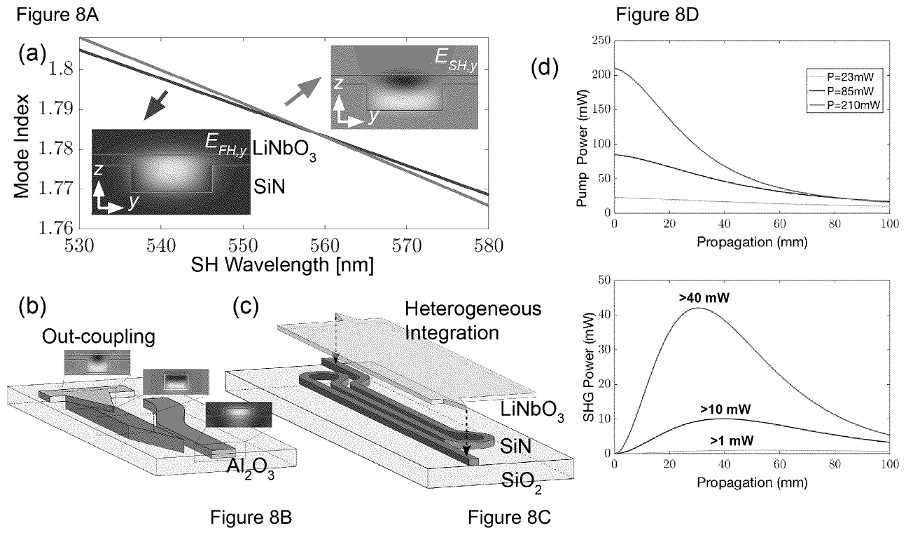

Some embodiments provide second Harmonic generation gain. Some embodiments use SHG as an alternative approach to achieve gain at the mid-band wavelengths. Using the same approach for direct gain and laser design as the other wavebands, low linewidth ECTLs in the extended-bands will be used to pump LiNbO₃ waveguides. FIG. 8A illustrates simulation of SHG phase-matching in accordance with an embodiment. FIG. 8B illustrates an out-coupling scheme in accordance with an embodiment. FIG. 8C illustrates LiNbO₃ membrane transfer to PIC in accordance with embodiment. FIG. 8D illustrates simulated pump (top) and SHG (bottom) power vs. waveguide length in accordance with an embodiment. The LiNbO₃ material is heterogeneously integrated with the PIC platform by transferring inverse tapered waveguide thin LiNbO₃ membranes onto waveguides in the PIC platform as illustrated in FIG. 8C. The phase-matching approach is inspired by a method where the second harmonic (SH) mode is a first-order TE-like mode, see inset in FIG. 8A. Simulations of the mode-index of the first harmonic (FH) and SH modes are shown in FIG. 8A as a function of the SH wavelength for a device geometry designed for λ_{SH}=560 nm. Here, the SHG mode overlap is, ζ=0.045/μm corresponding to a SHG conversion efficiency of about 4% (calculated using a split-step method assuming 1 dB/cm and 2 dB/cm loss at the FH and SH modes), see FIG. 8D. This is sufficient to reach 0 dBm output power by pumping with 23 mW. Certain embodiments can meet the target output power by increasing pump power to 85 mW and 210 mW, corresponding to 10% and 20% conversion efficiency, respectively.

Some embodiments lower the required pump power using CAAs in the extended-band and/or for the SHG outputs as well as increasing the conversion efficiency by reducing waveguide loss and/or using ring resonators. Looped waveguides, as shown in FIG. 8C, and ring resonators will be used to reduce the device footprint. With small device modifications, simulations show ζ(λ_{SH}=530 nm) is about 0.044/μm and ζ(λ_{SH}=600 nm) is about 0.042/μm, demonstrating that similar conversion efficiency is possible across all the mid-band wavelengths. Tunability of the phase-matching wavelength can be achieved by tuning the refractive index of the ultra-low loss waveguide through the stress-optic actuators of the PIC platform. The SHG approach has advantages such as: no periodic poling is necessary; no etched waveguides in LiNbO₃ are necessary since confinement is achieved with Si₃N₄ waveguides; the output SH mode may be converted to the fundamental TE-like mode of the Al₂O₃ waveguides in the PIC platform by a tapered directional coupler between the Si₃N₄ and Al₂O₃ waveguides, see FIG. 8B.

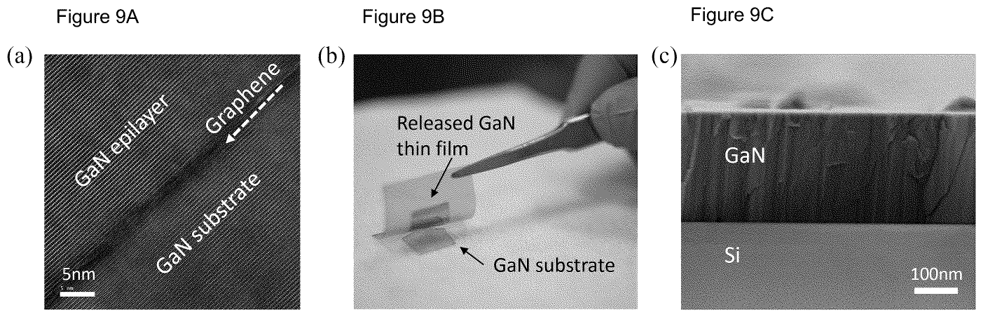

Certain embodiments provide thin membrane gain. Heterogeneously integrating the gain using III-V and GaN EPI materials onto the PIC platform can benefit from approaches that can bypass the wafer to die step between print transfer. Some embodiments can directly grow the PIC MC gain die by a remote-epitaxy process where the gain material is removable from its substrate directly to the PIC. High-quality III-V structures can be grown homoepitaxially with direct atomic bonding to substrates of the same materials. FIGS. 9A-9C illustrate remote epitaxial III-V thin films and integration in accordance with an embodiment. FIG. 9A shows cross-sectional TEM of GaN epitaxially grown on substrate mediated by ultra-thin 2D material layer. FIG. 9B shows remote epitaxial GaN released from the substrate and suspended on a polymer tape. FIG. 9C shows thin film GaN bonded onto a silicon substrate. With remote epitaxy some embodiments can exploit the weak van der Waals bonding between the GaN and III-V structures and their respective substrates by incorporating a mediated layer of ultra-thin 2D material. By fabricating the 2D material layer at atomic thickness, some embodiments can maintain the homoepitaxial relationship between the EPI structure and its substrate. Because of the weak van der Waals interaction, the EPI structure can then be released from its substrate, see FIG. 9B, and subsequently bonded onto an arbitrary surface through wafer bonding, see FIG. 9C. Additionally, the remote epitaxy process allows access to the two surfaces of the thin film and therefore fabrication at the proximate surface of the active region becomes possible, enabling new heterogeneous device structures with simplified integration and potentially improved performance. For example, the electro-optic effect can be enhanced by distance reduction of metal contacts to modulation medium.

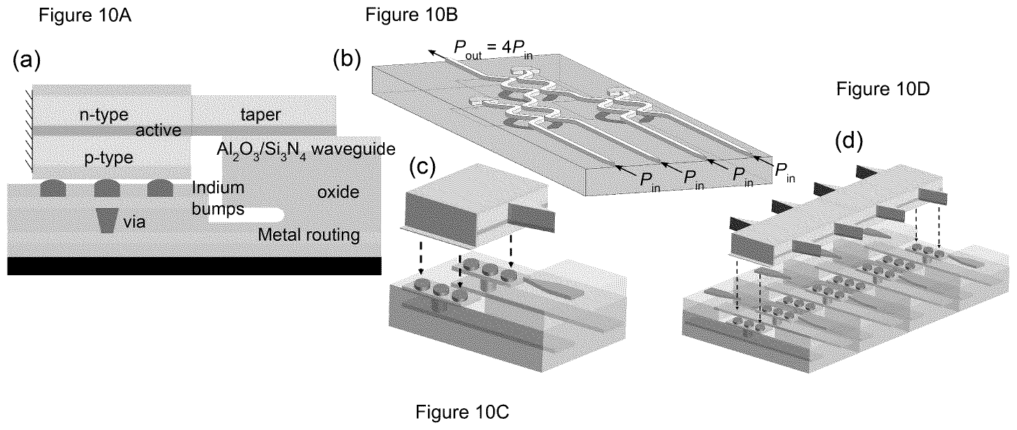

Some embodiments provide micro-chiplet (MC) EPI fabrication and integration. Gain integration (and photodetectors) can be achieved by processing the waveband EPI wafers into single and dual-taper gain die with complete optical and electrical connections that match inverse-taper pockets connecting the MC gain/detector die to the desired ultra-low loss waveguide layer and electrical interconnect layers. FIG. 10A illustrates a side view of integrated MC in accordance with an embodiment. FIG. 10B illustrates a CAA design showing a generic detector in accordance with an embodiment. FIG. 10C illustrates a 3D illustration of integration process in accordance with an embodiment. FIG. 10D illustrates a four-waveguide SOA for pre-amplification before CAA in accordance with an embodiment. Electrical and optical connections to the PIC platform are made by indium bonding contacts on the MC die to PIC metal layers and optical connection via inverse tapers, as shown in FIGS. 10A and 10C. Electrical connections are made through vias down to the CMOS layers, providing a path towards truly large-scale PICs and CMOS transistor-based control circuitry. As shown in FIG. 10A, the PIC waveguide sits on a movable cantilever formed by removing oxide underneath it using an amorphous silicon sacrificial layer. MC gain (and photodetector) die are lowered until the semiconductor tapered waveguide is sufficiently close to the PIC waveguide in the desired layer for partial evanescent coupling to occur. Measuring the transmission in-situ provides a feedback loop for optimizing the alignment in the horizontal plane. Once optimal coupling is achieved, the gain MC is lowered until it contacts the flexible waveguide and continues downward while pressing down on the indium bumps making them deform. The transfer stamp releases the gain MC after good optical and electrical connections are established. This process can be performed in a passive alignment mode. For the MC gain and SHG LiNbO₃ die, the process is similar to diamond membranes. To move beyond power levels set by the saturation power of the integrated SOAs, coherent amplifier arrays (CAAs) including stress-optic controlled MZI trees in the PIC platform can be fabricated, see FIG. 10B. Controlling the phase between the arms of each MZI allows for coherent addition of two phase-correlated input fields—effectively amplifying by a factor of N for N MZIs in the tree (less the splitting an excess losses). Monitoring output power in the MZI “dark” output port enables active feedback on the phase-shifters to compensate for phase drift. The PIC platform enables all on-chip feedback using reverse bias tapered SOA MC photodiodes for external CMOS control circuits.

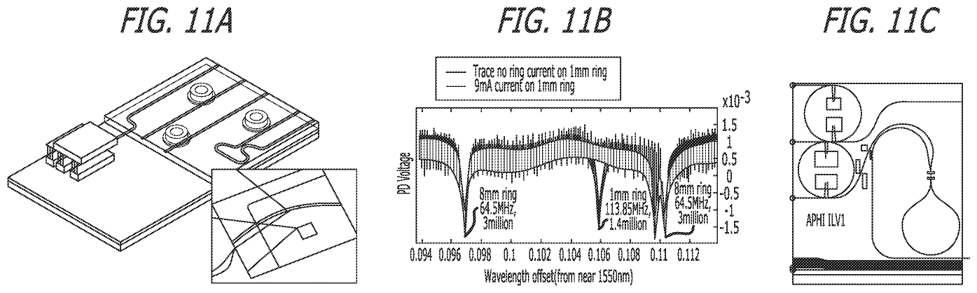

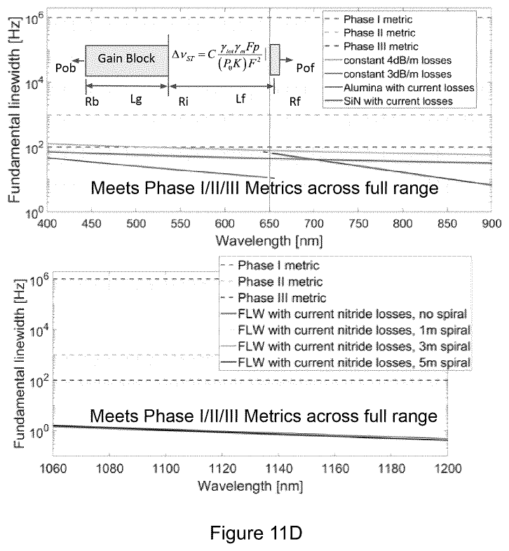

Several embodiments achieve the intrinsic ultra-low linewidth lasers with an extended cavity tunable laser (ECTL) design in each of the Si₃N₄ and Al₂O₃ waveguide layers for WB₁-WB₈. FIG. 11A illustrates an ultra-low linewidth tunable laser 3-resonator at 1550 nm. FIG. 11B illustrates tuning of 1550 nm ECTL. FIG. 11C illustrates 674 nm ECTL mask. FIG. 11D illustrates a model used to calculate intrinsic linewidth and plots showing fundamental linewidths at wavelength ranges 400-900 nm and 1060-1200 nm in accordance with an embodiment.

High-Q AlN stress-actuated resonators meet the linewidth and tuning requirements and the ECTL tunes across each of the eight 62.5 nm wavebands, providing operation at 400-900 nm wavelength. The design also supports 1060-1200 nm lasers for the SHG pumps for the secondary mid-band approach. The ECTL design (FIG. 11A) includes tapered waveguide gain die connected to the corresponding waveguide layer that contains high-Q resonators for Vernier tuning, photon reservoirs and a Sagnac loop mirror. Models of the ECTL intrinsic linewidth (FIG. 11D) shows that metrics are satisfied across all wavebands. Some embodiments incorporate vertically coupled Si₃N₄ and Al₂O₃ passive waveguiding layers for extra cavity length spirals. This approach allows to meet the requirement of 4/6/8 lasers and the flexibility for different wavelengths. The SHG chiplets (FIG. 3C) use ECTLs operating at 1060-1200 nm as pump lasers the same linewidth performance.

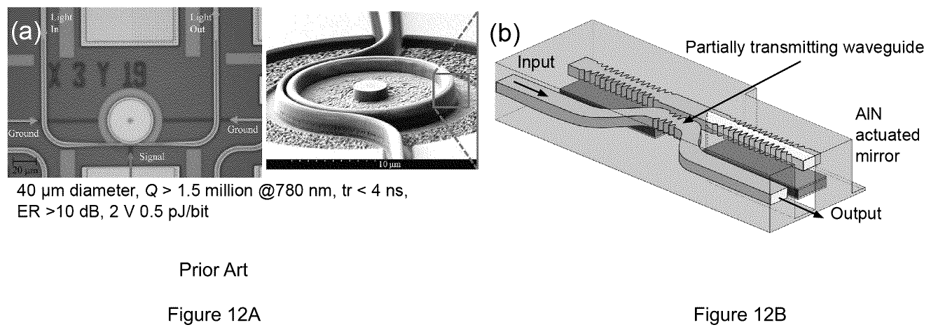

Several embodiments implement optical modulators and/or switches. Piezo-optomechanically tunable visible wavelength photonics with small foot-print, low voltage actuation (about 1 V), and large extinction (greater than about 50 dB) can be used to fabricate two modulator designs (See, e.g., P. R. Stanfield et al, Opt. Express 27, 28588 (2019), the disclosure of which is incorporated by reference.). FIG. 12A illustrates a coupled stress-optic AlN ring modulator. The ring modulator, fabricated for both Al₂O₃ and Si₃N₄, can operate out to 500 MHz as well as provide DC tuning. The ring resonator has a diameter of about 40 μm, Q greater than about 1.5 million at 780 nm wavelength, extinction ratio (ER) greater than about 10 dB at voltage about 2 V, tᵣ less than about 4 ns, and power at about 0.5 pJ/bit. The PIC platform has an inherently ultra-low power AlN stress optical layer that any waveguide can be selectively routed through by mask design only and connected to the metal interconnect layers. FIG. 12B illustrates a coupled stress-optic AlN modulator in accordance with an embodiment. The nanocavity modulator uses Fano resonances with large ER by small resonance shifts. The modulator includes Si₃N₄ or Al₂O₃ waveguides/ring-resonators, cladded in SiO₂, and are tightly mechanically coupled to a mechanical actuator. The actuator is a piezoelectric aluminum nitride (AlN) film with vertical field metal electrodes patterned above and below to produce mechanical actuation via the AlN piezoelectric response. The waveguide or ring-resonator sits on a SiO₂ optical buffer layer above the AlN top electrode and are mechanically responsive to the actuation. Electrical contact to the electrodes is made through tungsten vias and a patterned aluminum routing metal layer that sits below a SiO₂ spacer. Operational bandwidths of about 204 MHz and 233 MHz can be achieved in ring modulators and Mach-Zehnder modulators, respectively, using a similar architecture with a silicon nitride waveguide.

The device performance is determined by the thicknesses of all the layers in the system as well as the in-plane feature dimensions. FEM multi-physics simulations show that a simple reduction of bottom SiO₂ cladding thickness results in an increase of the first resonant mechanical eigenmode's frequency, and a bandwidth as high as 267 MHz and 417 MHz, respectively. Optimization can be performed for the 500 MHz metric. Propagation losses of about 0.3 dB/cm at 780 nm can be achieved in Si₃N₄. Some embodiments can achieve losses of about 1 dB/cm in ALD alumina waveguides clad in oxide at operation wavelengths near 400 nm.

On-chip detection can be achieved by dual-use of the gain MCs. Operating SOAs in reverse-bias enables extraction of a photo-current generated by absorption of optical fields in the active region.

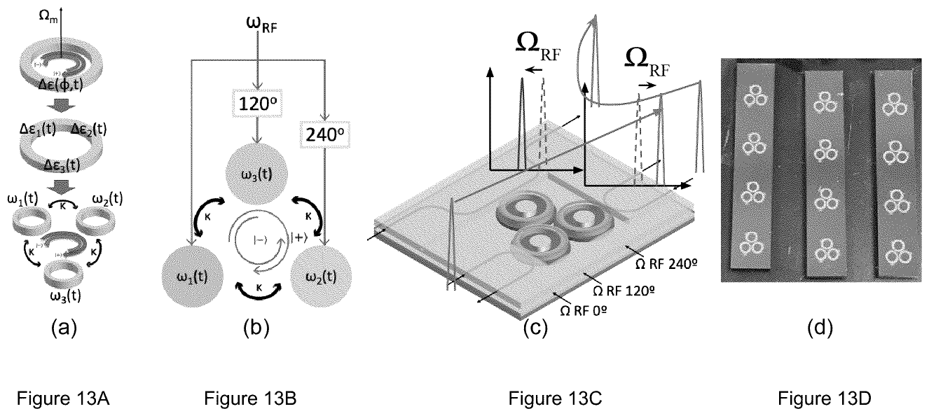

Some embodiments implement non-magnetic optical isolator/circulator (NMOI). FIG. 13A illustrates imparting equivalent angular moment via stress-optic index modulation in accordance with an embodiment. FIG. 13B illustrates three coupled ring nonmagnetic optical isolator with RF drive signals 120 degrees off-set from each other in accordance with an embodiment. FIG. 13C illustrates a schematic of implementation in PIC platform in accordance with an embodiment. FIG. 13D illustrates a fabricated three-port optical isolator/circulator in accordance with an embodiment. The non-magnetic 3-port isolator/circulator can be realized using the piezo-electrical AlN layer of the PIC platform to modulate the index of each of 3-coupled rings at a desired RF frequency that sets the optical isolation resonance split. The RF signal applied to each ring is offset by 120 degrees phase shift (FIG. 13A).

Some embodiments use bulk stress index modulation Δε(φ,t) in each ring (FIG. 13B). This modulation imposes an effective spin, with angular velocity Ωₘ, breaking reciprocity by introducing an asymmetric phase shift for counter propagating modes. The PIC platform supports all components of the design (FIG. 13C). Spatial-temporal modulation is discretized into three regions, breaking the constraint between electrical and optical signals. The bulk permittivity is modulated Δε1(t), Δε2(t) and Δε3(t) with fixed phase offset as shown in FIGS. 13B and 13C. As shown in FIG. 13C, the RF modulation produces an effective split resonance. A red wavelength injected into one port can route to a second output and a blue signal injected into the same port can route to the third output. If the red signal is injected back into the second output, it can be directed to the third output and not the first input. The resonator Q sets the filter width and the split is set by the RF modulation.

FIG. 13D shows a fabricated 3-port isolator test structures at 1550 nm. The preliminary results have a measured loaded Q of about 1.6 million and mechanical resonances around 270 MHz. This isolator/circulator decouples the RF drive frequency from the ring resonances, allowing MHz signals to be used for greater than about 20 dB port isolation/circulator functions. The optical isolators can be designed to accommodate driven lasers at wavelengths from 400 nm to 900 nm.

Some embodiments implement non-magnetic optical isolators and/or circulators. A non-magnetic 3-port isolator/circulator (FIGS. 13A-13D) can be realized using the AlN layer to modulate the index of each of 3 coupled rings at a desired RF frequency offset by a 120 degrees phase shift between rings. This isolator/circulator decouples the RF drive frequency from the ring resonances, allowing MHz signals to be used for greater than 20 dB port isolation/circulator functions. Certain embodiments implement optical detectors. The PIC platform can be fabricated in a CMOS foundry and can readily fabricate PIN photodiodes in silicon using mask-defined, high-energy dopant implantation and diffusion for the 400-900 nm range.

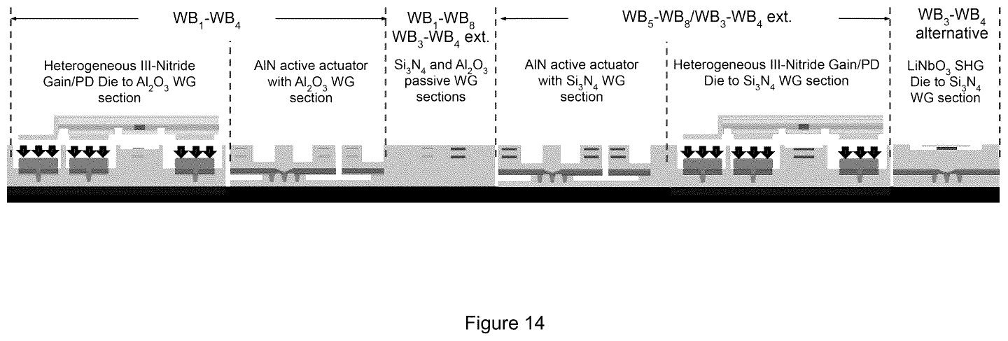

Many embodiments provide heterogeneous integration of the platform. The PIC platform is based on a piezo-optomechanically tuned Si₃N₄ photonics architecture. FIG. 14 illustrates a heterogeneous integration platform showing 8 epitaxially grown gain/laser materials platforms integrated onto the active photonic integrated circuit platform via a flipped transfer print process in accordance with an embodiment. FIG. 14 shows the heterogeneous architecture based on a transfer-print process of pre-assembled die from 8 EPI wafers onto the CMOS active PIC platform. A carrier with topology complementary to the PIC is used to pre-assemble die from the 8 EPI wafers and then stamp the pre-assembly on the PIC. Physical contact is made between the top optical layer of the die and the top of the Al₂O₃ and Si₃N₄ waveguide layers on the PIC, with adiabatic transfer by evanescently-coupled matched inverse tapers and electrodes on both sides with indium bumps.

Some embodiments use two independent waveguide layers fabricated from ALD-deposited Al₂O₃ (limited to about 150 nm thickness) and PECVD-deposited Si₃N₄, both with ultra-low-loss plasma enhanced TEOS oxide claddings. Less than about 0.03 dB/cm at about 780 nm wavelength in Si₃N₄ can be achieved and Al₂O₃ can be used in the platform as well. At least less than about 0.3 dB/cm loss at 600 nm wavelength can be achieved. Certain embodiments use a stacked pair of Al₂O₃ and Si₃N₄ waveguide layers separated by a thin silicon dioxide spacer. Thick, high-index-contrast SiO₂-clad Si₃N₄ waveguides can be used for long wavelengths (WB₅-WB₈). For shorter wavelengths, lower index contrast SiO₂-clad Al₂O₃ waveguides which have been shown to be low loss down to 400 nm can be used. Some embodiments implement a second pair of Al₂O₃/Si₃N₄ layers for long optical delay lines for ECTLs. Table 1 lists performance analysis of the platform.

TABLE 1
Wall plug efficiency calculations and metrics.

| | Steady-state power | |
|---|---|---|
| Component | consumption | Notes |
| Gain chip | 0.45 W | Assuming 300 mA |
| | | drawn at 1.5 V |
| AIN actuator for silicon | About 2 μW | Power to tune 2 |
| nitride or aluminum oxide | | resonators by ¼ FSR |
| ring resonator | | |
| Nitride TEC | About 1 W | Includes power to |
| | | run controller |
| SOA | About 1.2 W | 670 mA, 1.8 V |
| SOA TEC | About 1 W | Includes power to |
| | | run controller |
| Passive phase shifter | About 0.08 W | Assuming 40 mA |
| | | drawn at 2 V |
| AIN Modulators | About 14 mW | 7 nJ/bit every 1 μs, |
| | | 2 phase shifters/ |
| | | waveband |
| Total | 3.744 W, or | |
| | 1.544 W | |
| Output optical power I | 1 mW | WPE: 0.065% |
| Output optical power II | 10 mW | WPE: 0.267% |
| Output optical power IIi | 40 mW | WPE: 1.068% |

As shown in FIG. 14, the PIC integration platform contains active ultra-low loss waveguides with gain, ultra-low loss waveguides with AlN stress-optic actuation and SHG wavelength conversion. The active and passive sections are defined, accessed and routed by mask-only changes. Two independent waveguide materials, selected by mask-only changes, fabricated using TEOS-oxide clad ALD-deposited Al₂O₃ and PECVD-deposited Si₃N₄, provide routing for the lower/mid-bands and long/extended-bands. Several embodiments can provide a second pair of Al₂O₃ and Si₃N₄ layers for long optical delay lines for ECTLs if needed. Some embodiments choose the top alignment of the waveguide materials to make fabrication easier, but may explore having the two materials in different layers separated by about 500 nm. Several embodiments can achieve less than about 3 dB/m at visible wavelengths in Si₃N₄, or less than about 0.3 dB/cm at 780 nm in Si₃N₄ and have initial comparable results in Al₂O₃. Waveguides from either Al₂O₃ or Si₃N₄ layers can be routed by mask-only changes through the AlN stress-optic actuation layer, enabling designer defined actuated waveguide devices including tunable phase shifters, rings, modulators and isolators. For device and system level measurement electrical interconnects are available through mask-only changes to connect to any MC die, for AlN actuators, and for photodetectors. A wide variety of ultra-low loss passive components, including splitters, couplers, filters, resonators, surface gratings and delays, can be fabricated in both guiding layers. The designer can realize all active and passive components in the toolkit to fabricate ultra-low linewidth ECTLs, stimulated Brillouin scattering (SBS) lasers, SOAs, CAAs, optical modulators, optical blanking gates, nonmagnetic optical isolators, optical phase shifters, delay lines, grating emitters and other components.

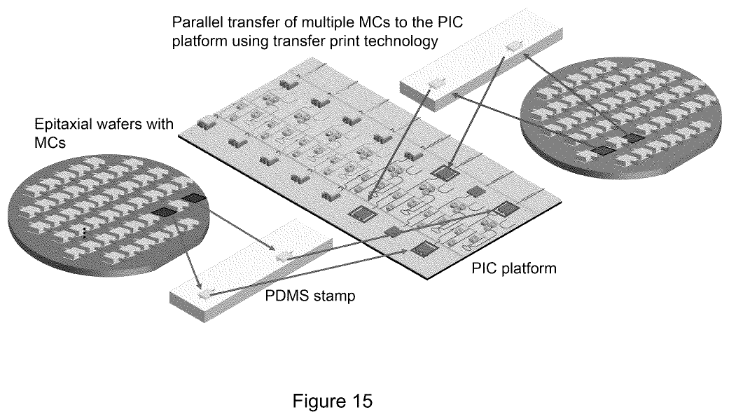

Some embodiments use transfer printing to integrate gain, photodetector and SHG MCs with the PIC platform. The process relies on kinetic control of the adhesion to polydimethylsiloxane (PDMS) stamps due to their viscoelastic behavior. These transparent stamps are mounted on precision stages containing an optical imaging system for visual monitoring. FIG. 15 illustrates a transfer printing process in accordance with an embodiment. FIG. 15 illustrates the process by which multiple MCs are transferred in parallel from each donor wafer to the PIC platform. Donor wafers correspond to EPI with optimized gain for different wavebands. Large-scale manufacturing can be envisioned with an assembly line of PIC wafers populated with MCs from EPI wafers. Certain embodiments may use a table-top transfer printing module, or tungsten needles to pick up individual MCs. Some embodiments implement methods to increase the alignment accuracy beyond about 1 μm, to achieve efficient coupling between waveguides in the MCs and PIC platform. For thin membrane MCs, some embodiments may co-design the MC and PIC platform with small lithographically defined features that fit together like Lego-pieces. For example, fabricating small bumps on the PIC receiving surface can keep the MC from making large area contact with the PIC surface, which reduces van der Waals adhesive forces. The MC may therefore be moved around until matching holes in it line up with the PIC bumps causing a large area of contact with much larger van der Waals forces, which snaps the MC into place. Alignment optimization by feedback from transmission measurements may be explored.

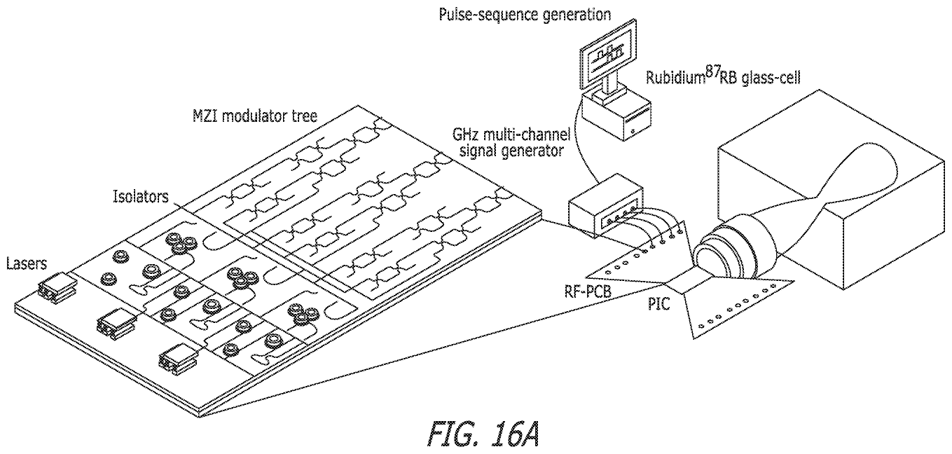

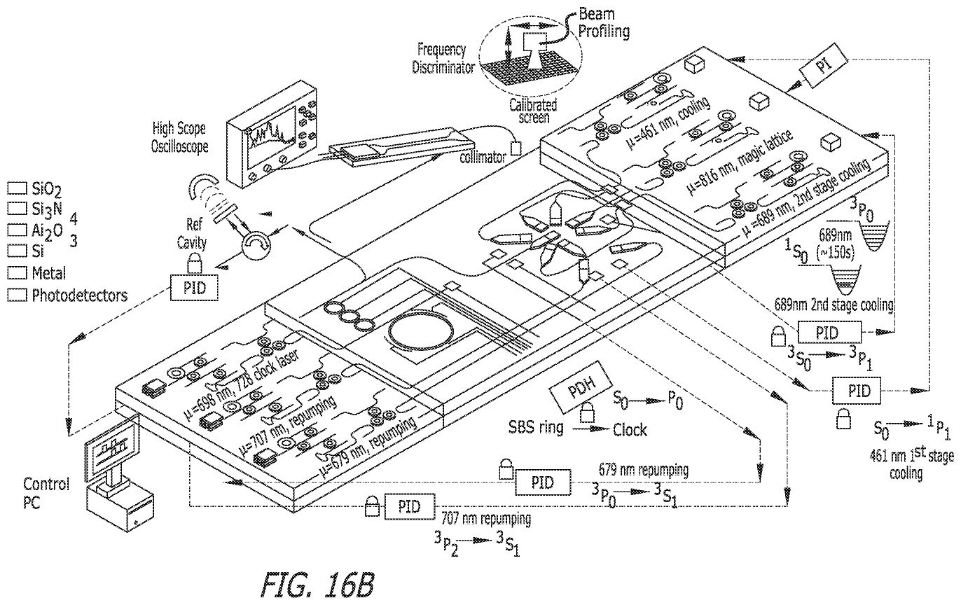

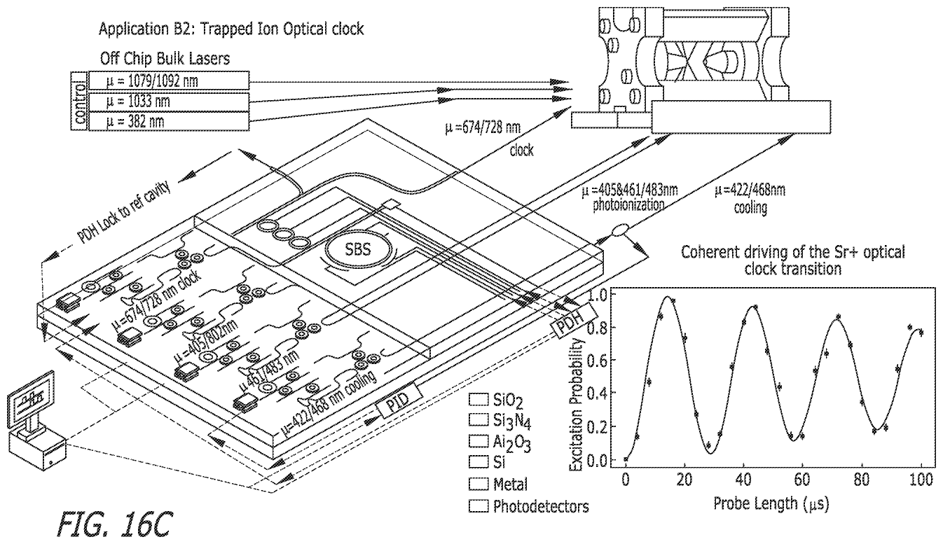

Some embodiments provide atom array quantum computing. Quantum computers have reached a scale where certain benchmarks may need quantum devices with a moderate number of qubits (˜100) to show quantum speedup. Some embodiments provide devices suitable for cold atom quantum computing using optical hyperfine gates and Rydberg entangling gates. FIG. 16A illustrates atom array quantum computing in accordance with an embodiment. The PIC can deliver 100 Hz linewidth beams for Rydberg gates (420 nm), cooling (780 nm), hyperfine-qubit gates (795 nm), and 1 MHz linewidth for trapping (810 nm). The demo chip can deliver beams to 32 sites with <5 ns on-off modulators for gate pulses. The quantum computing in accordance with certain embodiments focuses on evaluating gate-based digital quantum computing, specifically on estimating gate performance as summarized in Table 2.

TABLE 2
Quantum computing performance

| | PIC-supplied focal spots on atom sites |
|---|---|
| Number of qubit channels | 4; or 1024 |
| Qubit encoding | Hyperfine states |
| Gate sets | Single-qubit gates; k-qubit gates including |
| | k = 2 CNOT |
| Gate speed | Greater than 100 MHz |
| Single-qubit fidelity | Greater than 0.99 |
| Entangling fidelity | Greater than 0.99 (for k = 2 qubit gates); for |
| | k = 3 . . . 16, error should be less than |
| | k × 0.01 |

Certain embodiments provide strontium atomic clock laser cooling and OLO. Some embodiments integrate all lasers for cooling, trapping and probing strontium-87 atoms in a 1-D, magic-wavelength optical lattice. FIG. 16B illustrates strontium AC laser cooling and OLO in accordance with an embodiment. FIG. 16B shows on-chip lasers, tuning elements, detectors and the electrical interconnect, emission and controlled timing of 5 lasers for cooling and trapping and one laser for OLO: first-stage cooling (461 nm) 3 free-space beams intersecting orthogonally, 3 free-space beams cool the atoms to ˜1 mK in a MOT, with two repumping beams (707 nm and 679 nm). Second-stage cooling (689 nm) 3 intersecting beams and 2 repumping beams (679 nm, 707 nm). An 816 nm is used for trapping the cooled atoms in magic-λ lattice. Magic lattice wavelength (816 nm) emits from a focusing grating (beam size ˜50 μm). The clock wavelength (698 nm) will be a sub-Hz fundamental linewidth SBS laser stabilized to an off-chip 1 Hz integral linewidth reference cavity. The SBS laser will be pumped by a 674 nm ECTL. Demo of beam cycling, beam quality and OLO frequency stability of 1 Hz over 1 sec.

TABLE 3
Performance and measurement methodology for Sr-87 laser cooling and SBS OLO PIC.

| Wavelength | Role | Metrics | Measurement plan |
|---|---|---|---|
| 461 nm | 1^{st} stage | 3 dBm, 4 mm beam | Beam power: integrating sphere |
| | cooling | diameter, divergence half | Beam profile: large area sensor with |
| | | angle less than 1 degree | calibrated screen for beam uniformity, |
| 689 nm | 2^{nd} stage | About 30 dBm, beam | divergence, diffraction angle and size |
| | cooling | quality same as above, | Phase noise and QDEV measurements |
| | | linewidth in 10 s of kHz | |
| 679 nm, | Repumping | About 30 dBm in free | |
| 707 nm | | space, beam quality same | |
| | | as cooling beams | |
| 698 nm | Probe | 1 Hz linewidth over 1 sec, | Phase noise and QDEV measurements |
| | | 0 dBm power, beam size | with laser locked to external stable |
| | | 50 microns | cavity |
| 816 nm | Magic-λ | About 24 dBm power, | Beam profile: large area sensor with |
| | lattice | focusing beam size 50 | calibrated screen |
| | | microns | |

Some embodiments fabricate PICs to demonstrate a trapped ion optical clock. FIG. 16C illustrates a trapped ion optical clock operation in accordance with an embodiment. Testing can be done with a Sr ion clock and a Ra ion clock will be available for risk mitigation. It is important that for both ions, the most important wavelengths used for laser cooling and fluorescence detection as well as the clock transition wavelength are captured in the 400-900 nm wavelength range.

Some embodiments couple the lasers to optical fibers to deliver the light to the trapped ion optical clock with control over laser frequencies and amplitudes provided by the chip. Certain embodiments ensure the necessary controls for trapped ion optical clock operation are built into the PICs. This extends from basic hardware considerations, e.g. how far do the various PIC AOMs need to be tunable in frequency and what extinction ratios are required to prevent decoherence during clock operation, to software and timing controls. This input can be important to ensure that the integrated photonics will be properly integrated into a functional chronometer. The atomic clock systems will be used to test PIC lasers and PIC frequency and amplitude controls to prepare for full PIC integration.

For the strontium ion clock, the PIC lasers can photo-ionization load the ion trap via a two-photon process (461 and 405 nm). Some embodiments can laser cool and state detect with a laser at 422 nm, ion repumping (1079 nm) and clock state cleanout (1033 nm) will use bulk lasers. With the 674 nm laser some embodiments perform Rabi and Ramsey spectroscopy of the optical clock transition, cooling the ion to its motional ground state, and run the optical clock. The PIC can address the clock transition (728 nm), as well as three other Rat transitions (483 nm, 450 nm, and 802 nm).

### Doctrine of Equivalents

As can be inferred from the above discussion, the above-mentioned concepts can be implemented in a variety of arrangements in accordance with embodiments of the invention. Accordingly, although the present invention has been described in certain specific aspects, many additional modifications and variations would be apparent to those skilled in the art. It is therefore to be understood that the present invention may be practiced otherwise than specifically described. Thus, embodiments of the present invention should be considered in all respects as illustrative and not restrictive.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the terms “approximately,” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

What is claimed is:

1. An integrated photonic platform comprising:
at least one optical waveguide layer on a substrate, wherein the at least one optical waveguide layer comprises a plurality of active elements; and
at least one socket to connect each of the plurality of active elements;
wherein the plurality of active elements is optically and electrically connected using an epitaxial tapered waveguide micro-chiplet geometry.

2. The platform of claim 1, wherein at least one of the plurality of active elements is selected from the group consisting of: a gain element, a modulation element, a detection element, and a nonlinear optical element.

3. The platform of claim 1, wherein at least one of the plurality of active elements is selected from the group consisting of: a semiconductor laser, an extended cavity tunable laser, an optical amplifier, an optical modulator, a non-magnetic optical isolator, a non-magnetic optical circulator, a detector, a frequency shifter, and a free-space grating emitter.

4. The platform of claim 1, wherein the at least one socket further comprises at least one direct-gain tapered waveguide gain die.

5. The platform of claim 4, wherein the at least one direct-gain tapered waveguide gain die comprises a III-V semiconductor material.

6. The platform of claim 4, wherein the at least one direct-gain tapered waveguide gain die comprises a material selected from the group consisting of: GaN, InGaN, AlGaN, AlInGaP, InGaAs, InAs, AlGaAs, GaAs, InN, and AlN.

7. The platform of claim 4, wherein the at least one direct-gain tapered waveguide gain die comprises a material selected from the group consisting of: GaN, InGaN, and AlGaN, and the integrated photonic platform covers a wavelength range from 400 nm to 530 nm.

8. The platform of claim 4, wherein the at least one direct-gain tapered waveguide gain die comprises a material selected from the group consisting of: InGaN and AlInGaP, and the integrated photonic platform covers a wavelength range from 530 nm to 600 nm.

9. The platform of claim 4, wherein the at least one direct-gain tapered waveguide gain die comprises a material selected from the group consisting of: GaN, AlInGaP, GaAs, and InGaAs, and the integrated photonic platform covers a wavelength range from 600 nm to 900 nm.

10. The platform of claim 4, wherein the at least one direct-gain tapered waveguide gain die comprises a material selected from the group consisting of: AlN, GaN, AlInGaP, GaAs, InGaAs, and InP, and the integrated photonic platform covers a wavelength range from 200 nm to 1800 nm.

11. The platform of claim 1, further comprises a tunable LiNbO₃ or a barium titanate (BTO) second-harmonic-generation (SHG) laser chiplet that integrates into the at least one socket.

12. The platform of claim 11, wherein the platform covers a wavelength range from 530 nm to 600 nm.

13. The platform of claim 1, wherein the at least one optical waveguide layer comprises a material selected from the group consisting of: silicon nitride, aluminum oxide, tantalum pentoxide, and aluminum nitride, and the integrated photonic platform covers a wavelength range from 200 nm to 2350 nm.

14. The platform of claim 1, further comprises at least one of: a stress-optic actuator layer, and a metal interconnection layer.

15. The platform of claim 14, wherein the stress-optic actuator layer comprises aluminum nitride or PZT.

16. The platform of claim 1, wherein the substrate is a flexible substrate.

17. The platform of claim 1, wherein the platform is configured to be a portion of: a cold-atom based quantum computer, a cold-atom atomic clock, or a quantum sensor.

18. The platform of claim 1, wherein the platform is compatible with a CMOS foundry fabrication process.

19. The platform of claim 1, wherein a plurality of functional blocks comprises a plurality of chiplets connected to the at least one optical waveguide layer, wherein at least one of the plurality of chiplets is selected from the group consisting of: a semiconductor gain, a nonlinear optical element, a modulator, a frequency shifter, a detector, and an optical amplifier.
